(19) United States
(12) Patent Application Publication
(10) Pub. No.: US 2007/0098364 A1
(43) Pub. Date: May 3, 2007

(54) System for making a personalized digital recording

(76) Inventors: Allan M. Toennis, Boise, ID (US); Valerie J. Davidson, Boise, ID (US)

Correspondence Address: ROBERT L. SHAVER;DYKAS, SHAVER & NIPPER, LLP, PO BOX 877, BOISE, ID, 83701, US

(21) Appl. No.: 11/250,534

(22) Filed: Oct. 13, 2005

(51) Int. Cl. H04N 7/00

(52) U.S. Cl. 386/95

(57) ABSTRACT

The invention is a system for producing a production run of recordings on digital media, in which each recording of the run is unique and each contains personal information of some type relating to an individual in a group. The personal information can be a photo of an individual imprinted onto the surface of the media or other label type information, or digital information on the recording.

### FIELD OF THE INVENTION

The invention relates generally to a system for making a personalized digital recording, particularly to a system for making each recording of a run of recordings unique and personalized to an individual.

### BACKGROUND OF THE INVENTION

Individuals are involved in various group activities in their lives, such as going to high school or college, being on a memorable cruise, being on a soccer team or other sports activities, or any number of activities with other individuals. Some of these group activities come with a way to record and share memories of that group activity. In high school situations, this can often be a yearbook which contains photos of the students, the faculty, various teams, quotes by students, videos of student activities and interesting pictures of students. The traditional format for recording images such as these has been paper, and has been in the form of a yearbook in the example of a school group activity. Other activities can have some equivalence to a yearbook which records information, photos and text about a particular group activity. More recent media for recording such things has included digital media. This can be in the form of CDs, DVDs, and other digital media. With the availability of digital media recording devices, added flexibility and customization is possible in recording group activities. It is preferable to include personalized information of an individual within the group in some way on the digital media. A preferable system would be one in which a production run of digital media recordings are made, with each recording having a personalized content which is tailored to or selected by an individual in the group.

### SUMMARY OF THE INVENTION

The present invention is a system for making a digital recording of events that relate to a group of people. These events can be school related activities, such as team sports, clubs, plays, dances and other school related activities. Other group events could be activities that are related to a cruise. These could include dances, contests, performances, ship tours, ports of call, shipboard activities and other cruise related events. Other group events could include events related to an employer, college, military, fraternal organizations, sports teams and weddings, for example.

The digital media on which these group events are recorded is personalized for an individual participant in the event. In the case of school related events, the recording would be individualized for a particular student. A production run of recordings would be made, with one recording being made for each individual, and with each individual receiving a recording with personalized content. In the case of a cruise related event, the recording would be individualized for a particular cruise participant. Other group events could include events related to a work place, a group vacation, a tour or any other group event that could be memorialized to become a collectible or memento for a participant.

The digital recording is placed on a memory storage device, which could be a CD, a DVD or another memory storage device. Each CD or DVD contains the digital recording, and includes at least one personalization item specific to a purchaser. The personalization item can be the purchaser's photograph, a saying made up by the user, the individual's favorite quotation, titles or other information specific to an individual. The DVD can also be personalized by adding the name of school or cruise, the year and the school mascot or a symbol for the non-school group activity. The recording can be personalized by adding personal information to the label of the recording, imprinted onto the surface of the recording, or added to the digital content of the recording.

The recording may be made so that it contains music which can be selected by the user. The music presented for selection by the user is a set of music pieces for which copying has been authorized by the copyright owners. Obtaining the copyright owner's permission to copy music is a huge benefit, and resolves a huge potential liability to a school or other organizations in preparing a recording that contains any music. In this way the resulting recording will have music that is selected by the user, and the user is guaranteed that the music selections will not have problems with copyright infringement. The music selection can be chosen so that each digital recording produced has the same music, such as by a committee equivalent to a high school yearbook committee. The video can also be manufactured so that the music of each recording has a selection of music chosen by the individual purchasers.

The invention is also a method of producing digital recordings. The method includes the steps of making one or more digital recordings of group events. The group events can be as described above, including school events, cruise events, work events, tour events, sport events, vacation events or other events involving groups of people. The recording could include photos, videos, music, text or other media types. The next step involves creating a database of names of individuals of the group whose events are recorded. Within the database is also recorded at least one personalization field for each name on the list. Personal fields can include a photograph of the person, his/her favorite saying or quotation, the school mascot and name, music selections, titles, text selections, video files, etc. Included can be a step of compiling approved music pieces into a music database for which permission of the copyright owner to copy and record them has been received. Another step is to create a database of group events, containing text, videos, photos, or other type of data.

The next step is to allow the user to choose music pieces. The next step is to create a digital recording on digital storage media, such as a CD or DVD, containing selected digital recordings of the group events and selected music. The last event is printing at least one personalization item on each digital storage medium. For each DVD thus made, an individual user can select various music selections to go with the recording. Alternatively, a group equivalent to a high school yearbook committee can select the music selections that will be on all of the DVDs that are made for those events for that school. Alternatively, each recorded DVD can be customized with music selections chosen by the individual purchaser, and with data files specific to an individual, such as photos, text, videos, menu information, selected friends, and other personal selections. As described above, the music selections would be selected from a list of musical pieces for which permission to copy them had been obtained. This eliminates copyright problems in adding music to the video recording.

In case of school events, the digital recording could be a supplement to the printed school yearbook or could be expanded to be an alternative to or to replace a school yearbook. The digital recording could include a menu system for selecting scenes and selections to view, and could include still photos and photos in a slideshow format, as well as text and video clips.

The database of information could also include audio recordings of group participants, audio and video recordings of interviews, question and answer sessions or other personalized pieces. The video could have an audio recording for each group participant or could have still photographs with which are associated the audio recordings of the individual shown. Such a format could be adapted to supplement or replace a traditional yearbook at a school. A similar format could be used to make what amounts to a yearbook for a cruise, a video/slide show for a sports team that has video clips and still photos from the sports season, or a work related video with instructional material, or tour and staff videos similar to a yearbook.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a diagram of the recording system of the invention.

FIG. 2 is a diagram of the recording system of the invention with multiple databases and output screens.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

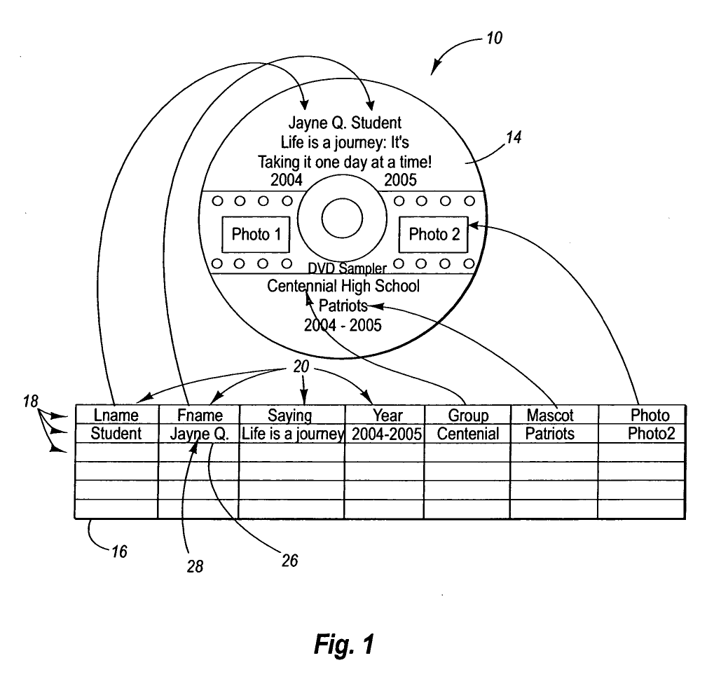

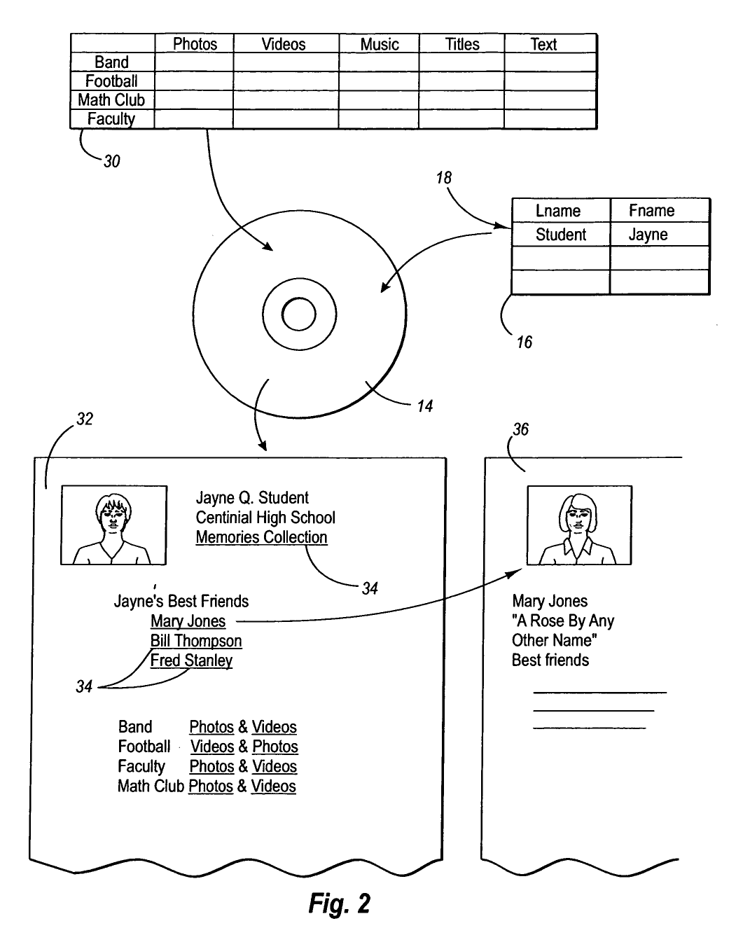

The recording system of the invention is shown in FIGS. 1 and 2. One embodiment of the invention is a system which results in a production run of digital recordings, such as CDs or DVDs, in which each recording in the run has different content than the other recordings in the production run. The difference between one recording and another in the series is that each recording will have different personalized information about an individual member of the group. The invention is particularly suitable for producing recordings involving a group of people, with each person in the group receiving their own personalized recording of group activities. One way in which this system can be utilized is in a school setting. Digital files relating to school activities would be recorded in a production run on a group of digital media such as DVDs. For purposes of this discussion, the digital media will be referred to as DVDs, with the understanding that other digital media falls within the concept of the invention, and could include DVDs, CDs, flash drives, portable hard drives, and other forms of digital media.

In the case of a school activity, a name database 16 of information would be populated with each record 18 in the database 16 relating to information about a student. At the very least, this information would contain the student's name, but other personal information could be recorded in as an entry in a field of the database 16, with each record 18 of the database 16 containing such information as first name, last name, the student's favorite saying, the school year covered, the name of the school, school mascot, one or more photos of the student, one or more names of the best friends of the student, menu information, and other information that is particular to an individual student.

Information from this database would be combined with a particular recording of digital files related to school activities, with information from each student being expressed in the digital recording in some way.

FIG. 1 shows the recording system 10 in which a name database 16 is populated with information about individuals in a group. Personal information about each individual is recorded in records 18 in the database 16. The name database 16 is divided into fields 20 with each field being a category of personal information such as last name, first name, student's favorite saying, etc. Where a record 18 and a field intersect is a cell 26 and the information in the cell is an entry 28. Also shown in FIG. 1 is an individual recording 14 which is one recording out of a production run processed by the recording system 10. Each individual recording 14 in the production run would be different than all of the other individual recordings of the production run. The difference would be in the information from the database 16 which is expressed in the individual recording 14.

In the embodiment of the recording system shown in FIG. 1, the individual information from the database 16 is expressed in the individual recording 14 in the form of information printed on the label. This information includes at least one of the student's name, the student's favorite saying, photographs of the student, the school name and the school mascot. This information could be printed to a label which is affixed to digital media 14. Preferably, this information is printed directly on the DVD in the form of directly printed artwork. This artwork is preferably imprinted onto the physical structure of the DVD surface, is water insoluble, and is a permanent addition to the material of the DVD 14 and is not just a paper based label.

Another version of the recording system of the invention is shown in FIG. 2. In FIG. 2 the name database 16 is still present with record 18, which is specific to Jayne Q. Student. An individual recording 14 is also made with information combined from name database 16 and group database 30. Group database 30 contains records which relate to group activities. In the case of a school activity, these records could be specific to band, football, math club, faculty, the prom, homecoming and other activities. The fields of the group database could included categories such as photo 1, photo 2, photo 3, etc., video 1, video 2, video 3, etc., music selection 1, music selection 2, music selection 3, etc., titles for group activities and text for group activities. Information from group database 30 and name database 16 could be recorded onto an individual recording 14 in such a way that a production run of DVDs would include personalized label information as well as personalized digital content information so that each individual recording 14 was unique. A third database (not shown) for music is also an option.

As shown in FIG. 2, the content on the digital recording could be displayed with individual entries and with a selection of content, and the selection of content could be changed based on the individual's selections. The information displayed in FIG. 2 shows that when the information on the DVD is displayed to the user, whether on a computer screen or on a television or other display device, it would contain information specific to the student. In this case, Jayne Q. Student's photo is displayed, her name is displayed, along with the high school, list of her best friends, and headings for group information about band, football, faculty, math club, etc., which could be in the form of text, photos and videos. These are shown in a display 32 which is a display of digital information from the DVD 14. The display 32 could include active links 34 which could be activated by a viewer to bring up a second display 36 with information indicated by the active link. For instance, if the active link for Jane's best friend Mary Jones were activated, a second display 36 would appear with information specific to Mary Jones. This could include photos, videos, or Mary Jones' selected favorite saying.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A recording system for recording a personalized recording on digital media, comprising:
a database of digital information, comprising a collection of digital files relating to group events and individuals within said group, including at least one category of personal information, and at least one category of group events, with said one category of personal information containing at least one entry of digital information specific to each individual of said group;
a digital media recorder for recording a plurality of recordings for individuals within said group, with each recording including said collection of digital files as data on said media, and with each recording including at least one entry of personal information specific to an individual, so that each copy of said media recording contains different content than all other recordings recorded from said database.

2. The recording system of claim 1 in which said entry of personal information is expressed in the recording as information printed on a label.

3. The recording system of claim 1 in which said entry of personal information is expressed in the recording as information imprinted directly on the digital media.

4. A recording system for recording a personalized recording on digital media, comprising:
a database of digital information, comprising a collection of digital files relating to group events and individuals within said group, including at least one category of personal information, and at least one category of group events, with said one category of personal information containing at least one entry of digital information specific to each individual of said group;
a digital media recorder for recording a plurality of recordings, with each recording including said collection of digital files as data on said media, and with each recording including at least one entry of personal information specific to an individual, with said entry of personal information expressed in the recording as information imprinted directly on said digital media, so that each copy of said media recording contains the same digital content but different label content as all other recordings recorded from said database.

5. The recording system of claim 1 which comprises a plurality of categories of personal information, with entries of personal information from said categories of personal information is expressed in the recording as information printed on a label, with each recording printed from the database having different information printed on said label from other recordings recorded from the same database.

6. The recording system of claim 5 in which said categories of personal information includes an individual's name which is printed on said digital media, with each recording printed from the database having a different individual's name printed on said label from other recordings recorded from the same database.

7. The recording system of claim 5 in which said categories of personal information includes one or more photos which are printed on said digital media, with each recording printed from the database having one or more photos printed on said label from other recordings recorded from the same database.

8. The recording system of claim 5 in which said categories of personal information includes a title selected by an individual in the group, with said title printed on said digital media with each recording printed from the database having different title information printed on said label from other recordings recorded from the same database.

9. The recording system of claim 5 in which said categories of personal information includes text selected by an individual in the group, with said text printed on said digital media, with each recording printed from the database having different text information printed on said label from other recordings recorded from the same database.

10. The recording system of claim 1 in which said entry of personal information is expressed in the recording as digital information recorded with said collection of digital files relating to group events.

11. A recording system for recording a personalized recording on digital media, comprising:
a database of digital information, comprising a collection of digital files relating to group events and individuals within said group, including at least one category of personal information, and at least one category of group events, with said one category of personal information containing at least one entry of digital information specific to each individual of said group;
a digital media recorder for recording a plurality of recordings from the database, with at least one recording for each individual of the group, and with each recording including said collection of digital files as data on said media, and with each recording including at least one entry of personal information specific to an individual, with said entry of personal information recorded as a digital file on said recording for later display if a graphic file, or for later play if a sound file, so that each copy of said media recording from said database contains different digital content from all other recordings recorded from said database.

12. The recording system of claim 11 in which said categories of personal information includes one or more photos which are recorded as digital files on said digital media for display with other files from said database, with each recording printed from the database having a different digital content from other recordings recorded from the same database

13. The recording system of claim 11 in which said categories of personal information includes an individual's name which is recorded as a digital file on said digital media, with each recording printed from the database having a different individual's name recorded on said recording, and having a different digital content from other recordings recorded from the same database.

14. The recording system of claim 11 in which said categories of personal information includes one or more titles selected by an individual in the group, with said title recorded on said digital media as a digital file, with each recording printed from the database having different title information recorded from other recordings recorded from the same database.

15. The recording system of claim 11 in which said categories of personal information includes text selected by an individual in the group, with said text recorded on said digital media as a digital file, with each recording printed from the database having different digital information recorded from other recordings recorded from the same database.

16. The recording system of claim 11 in which said categories of personal information includes one or more video files which are recorded as digital files on said digital media for display with other files from said database, with each recording printed from the database having a different digital content from other recordings recorded from the same database.

17. The recording system of claim 11 in which said categories of personal information includes a plurality of data fields selected by an individual in the group, with said data fields recorded on said digital media as digital files, with each recording of a run printed from the database having different digital information recorded from other recordings recorded from the same database.

18. A recording system for recording a personalized recording on digital media, comprising:
a database of digital information, comprising a collection of digital files relating to group events and individuals within said group, and a plurality of categories of personal information, and at least one category of group events, with said plurality of one categories of personal information containing entries in each personal category with information specific to each individual of said group;
a digital media recorder for recording a plurality of recordings from the database, for producing a production run with at least one recording for each individual of the group, and with each recording including said collection of digital files as data on said media, and with each recording of the run including information from the personal information categories specific to an individual, with said entries of personal information recorded as either an image on the recording label or as a digital file on said recording for later display if a graphic file, or for later play if a sound file, so that each copy of a run of said media recordings from said database contains different digital content from all other recordings recorded from a production run from said database.
